(19) United States
(12) Patent Application Publication
(10) Pub. No.: US 2010/0322995 A1
(43) Pub. Date: Dec. 23, 2010

(54) FISH FOOD CAPSULE

(75) Inventor: Jens Geselle, Kyritz (DE)

Correspondence Address: PAI PATENT & TRADEMARK LAW FIRM, 1001 FOURTH AVENUE, SUITE 3200, SEATTLE, WA, 98154, US

(73) Assignee: AYANDA GMBH & CO. KG, FALKENHAGEN, Pritzwalk (DE)

(21) Appl. No.: 12/738,832

(22) PCT Filed: Oct. 16, 2008
(86) PCT No.: PCT/DE08/01690

§ 371 Date: Aug. 9, 2010

(30) Foreign Application Priority Data
Oct. 19, 2007 (DE) 10 2007 050 888.5
Oct. 19, 2007 (DE) 20 2007 014 855.0

(51) Int. Cl. A23K 1/00; A01K 97/04

(52) U.S. Cl. 424/442; 426/89; 426/1; 426/72; 426/92; 426/289

(57) ABSTRACT

The invention relates to a fish food capsule, comprising a capsule casing and a liquid or suspension-like fish food product enclosed in the capsule casing, wherein a gas phase determining the buoyancy of the fish food capsule is provided in the fish food capsule, and to the use thereof, a fish food kit, and a method for producing the fish food capsule.

The invention relates to fish food capsules which comprise a capsule casing and a liquid or suspension-like fish food product enclosed in the capsule casing.

Fish foods, angling baits and angling lures are produced and offered in the most varied forms. There are products that are close to nature, and also specially composed mixtures which are then administered in the most varied forms.

The close-to-nature foods and angling baits are the first products used for this sector since they represent the “true” food of the fish and are relatively easy to procure.

Water fleas, meat larvae, freshwater shrimps, flies, worms, housefly larvae, brine shrimp and other small creatures are administered to ornamental fish in living, frozen and also dried form, but are also used as angling bait. Plant parts and fruits such as, for example, corn, wheat and other cereal types are customary foods and/or baits for farmed fish and sport fish.

Many of these close-to-nature foods and angling baits are used as components of food and bait mixtures.

A further large group of products of food and angling bait types is dried food. This concerns food mixtures consisting of animal and also plant starting materials which are sometimes enriched with vitamins, preservatives, therapeutic agents and drugs.

Depending on the dosage form, the most varied production methods exist, wherein the food mixtures used are generally very similar.

Flake food is a food mixture cut into fine slices which are then freeze-dried. Owing to the production method, these flakes have a rough side and a smooth side due to the cutting. According to on what side the flakes meet the water, the flakes sink; those with the rough side on the water surface fall more rapidly than the flakes which float with the smooth side on the water surface. This property of the flakes is described by the supplier as an extra desired advantage. Flake food is available in the most varied types.

Granules, boilies and pellets are produced as are flakes from similar food mixtures, only they are generally treated with thermal drying processes.

Granules and boilies sink immediately to the bottom owing to their composition, whereas in the case of pellets, both sinking and floating products are offered.

Tablets and chips are food types which consist of mostly pulverized starting materials and are pressed in a mold. The starting materials used are, inter alia, dried food animals, flakes, pellets and also plant parts. Tablets and chips usually sink immediately to the bottom and are intended for the creatures living there.

Lures are angling baits which serve for luring fish. Lures are offered in powder form. This food mixture is moistened and molded by the angler shortly before use. The resultant lumps are thrown into the water where a “food cloud” consisting of fine components then forms from the disintegrating lumps, which food cloud lures small fish owing to its odor.

Furthermore, drug-containing flakes and tablets are known. These are food mixtures admixed with therapeutic agents and/or drugs. These are primarily used for treating bacterial diseases and also to combat parasite infestation.

The publication WO 2005/115341 A2 describes microparticles and microbeads which comprise an indigestible polymer matrix in which fish food components are enclosed and which is additionally surrounded by a protecting shell.

A further fish food production method is microencapsulation in which, for example very small food creatures or algae are sprayed as core material together with a sheath material and are thus preserved.

Pure liquid fish food which contains suspended phytoplankton and zooplankton is offered for growing fry or invertebrate water creatures such as sea anemones or corals.

In addition to the feeding of ornamental fish and farmed fish, fish food products are used as lures and baits in sport fishing. These are generally food and bait mixtures which are incorporated into doughs and pastes. The pastes are a food mixture which is provided in paste form and consists of various food animals. Angling doughs exist in two types. One variant is prepared dough mixtures which are packaged in tubes or jars and are used immediately by the angler. The second form is powder mixtures which are stirred with water before use. Both food mixtures contain plant and animal components and also flavorings.

A disadvantage of foods which contain living food animals is that these animals have a natural flight instinct. This property leads to their hiding in aquaria, farm tanks or ponds and multiplying in an uncontrolled manner there or dying off. This can have a lasting effect on the water quality and the ecology of the waters. Similar problems are also provided by foods such as food pastes, sinking frozen food and dried food animals which are not consumed immediately.

Many dry food mixtures have a tendency to become watered down. This means that immediately after the food is introduced into the water, the odor, flavoring and coloring substances dissolve. As a result of this property, firstly the water becomes fouled and secondly fish no longer consume this food. Food which lies on the bottom in cracks and gaps is only accessible to a few fish types so that a majority of the food remains unused and decomposition products thereof likewise lead to a change in the ecological climate in the aquarium, pond or farm tank. Generally, decomposition of the food leads to overfertilization of the habitat which can be expressed, inter alia, in an algal bloom.

Drug-containing flakes and tablets are consumed by most fish only very reluctantly or not at all. The reasons for this behavior are the odor and flavor particles which are perceivable as adverse by the fish and which flow out from the drug-containing flakes and tablets.

“Liquid food for fish” is used only unenthusiastically by many aquarium operators, since most microencapsulated very small food animals and algae rapidly sink to the bottom and are therefore unsuitable for the growth of small young fish since these require floating food. In the case of the growth of fry, the rule applies that the fish should be stationary in the food.

In summary, the known fish food products and also lures and baits have considerable disadvantages. Many food and bait types rapidly lose their odor, flavor and coloring substances, that is to say they become watered down. Others do not have acceptable odors and tastes for the fish or rapidly sink to the bottom. These properties have the effect of restricting consumption by the fish, which leads to a change of the ecological climate of the habitat of the fish.

A further disadvantage of the known fish food is that the food cannot be offered according to the habitats, i.e. the water depths, in which the fish predominantly live. Fish types which live on the bottom do not swim, or only rarely, to the water surface, in order to consume food. For sufficient feeding, the food must first have sunk to the bottom. In contrast, fish which live close to the water surface do not consume food particles which have sunk to the bottom.

The requirements which are made of an optimized fish food are therefore:
1. high acceptance during consumption owing to the flavorings incorporated;
2. it must be producible in many colors and shapes;
3. the content is rich in vitamins, nutrients and/or lure substances;
4. it offers protection of the ingredients from becoming watered down;
5. components which are not consumed are biodegradable, but without changing the ecological climate of the habitat of the fish in a lasting manner;
6. the sink, suspension, or float behavior is individually controllable by the composition;
7. in the case of lures and baits, the lure substances are given off into the surroundings slowly;
8. the development of odors and flavors which are unpleasant to fish and which can be formed, for example, by means of medicament additions, are minimized or even excluded;
9. the fish food product is producible industrially and cheaply in high and constant quality;
10. the fish food can be offered and is accessible to the fish in a lasting manner in their preferred habitat, for example at a certain water depth.

Said requirements are met by a fish food capsule which comprises a capsule casing and a liquid or suspension-like fish food product enclosed in the capsule casing and also a gas phase determining the buoyancy of the capsule.

A suspension-like fish food product is a food which comprises a suspension, i.e. a heterogeneous mixture of matter, in which solid particles are distributed in a liquid.

The capsule casing is used as transport means, lure and packaging and also as a component of the diet.

The capsule casing comprises a material which can be consumed safely by the fish. Such materials are, in particular, gelatins of animal origin, alginates, starch, polyvenyl alcohols, chitosans, carrageenan, cellulose derivatives, Eudragit®, and other immobilized materials which are metabolizable or excretable by water creatures. Preferably, the capsule casing, after administering food, dissolves without residue in the water in a time period of preferably 0.5 to 3 hours, in particular in a time period of 1 to 2 hours. The capsule casing, in a particular embodiment, is stable over a broad range with respect to light and temperature effects, and also to pH changes and chemically and biologically active ingredients. At the same time, the membrane is configured in such a manner that during storage of the food capsule neither components of the food nor the gas phase can exit, and thus the properties of the fish food capsules are retained over a long storage period. In particular, soft gelatin capsules have the required membrane properties.

Odor and flavor substances can be incorporated into the capsule casing. This offers the advantage of being able to conceal or mask flavor and odor substances which are perceivable by the fish in a negative manner and which can be inherent components of the fish food product or of the drug. At the same time, these flavor and odor substances can lure the fish. Such lures can be aromas, essential oils, extracts of animals or plants, for example worm or algal extracts, flavor carriers such as spices, algae or other substances which are readily consumed by the fish and stimulate them to eat the fish food capsules.

The capsule casing can also be colored. Here, preferably, food colors or dyes which are harmless to health are used. The fish food capsules can be of a single color or multicolored.

The fish food capsules can comprise two or more capsule parts which contain different compositions of a fish food product, drug, or a combination thereof. For example, in the case of the production of soft gelatin capsules, these can consist of two gelatin capsule halves, wherein these can contain different gelatin mixtures. The food capsules parts can be of different colors. Likewise, the viscosity of the fish food product can be different in the respective food capsule parts. Therefore, a fish food capsule can be generated which firstly has a region in which liquid or low-viscosity fish food products, flavorings and/or odor substances are present, and secondly a region which can be highly viscose or else solid. Such fish food capsules are preferentially used in sport fishing. The solid region of such a fish food capsule serves for being able to fix the fish food capsule to fish hooks or other fishing accessories. When the fish food capsule is applied to a fish hook, the capsule, such as a commercially available bait, is skewered with the solid region on to the fish hook and thus fixed. The region of the capsule which contains the liquid or low-viscosity food, flavors and/or odor substances, in particular lures, serves for baiting the fish. This capsule region can be established in such a manner that the lures and food substances are released slowly. The release can proceed by dissolution of the capsule casing in the aqueous medium or by mechanical action. In a further embodiment, the fish food capsules can comprise capsule parts which contain or comprise aromas, colors and gel strengths differing from one another.

The liquid or suspension-like fish food product preferably comprises a liquid lipophilic base mass, in particular a vegetable or animal oil, in which further additives such as liquid and/or solid food components are incorporated. Also, the lipophilic base mass can be a water-in-oil emulsion. Further food components are, preferably, vitamins, carotinoids, dissolved minerals and trace elements, proteins and/or carbohydrates and also fibers. In a preferred embodiment, milled or pulverized food animals are incorporated in the lipophilic base mass.

In the further course of the description, when the fish food product is cited, not only a pure liquid fish food product, but also a suspension-like fish food product is meant.

The floating and buoyancy properties of the fish food capsule can be set via the proportion of the gas phase to the surface volume ratio and the weight of the fish food capsule. The capsule casing cannot be reduced arbitrarily, owing to the production process and its stability, and the use of “light” ingredients, likewise, cannot be increased arbitrarily. As a solution to the problem, a gas phase situated in the capsule is cited.

Enriching the capsule casing with gas bubbles is not very expedient, since as a result the stability and permeability of the membrane and therefore the density are affected. By forming a gas phase in the interior of the capsule, these problems are solved.

Depending on the selected size of the proportion of gas phase per capsule, the fish food capsule can be a floating capsule, i.e. driven to the water surface, or a suspended capsule, i.e. stationary at a certain water depth, or else a sinking capsule.

This offers the advantage of being able to offer food to the fish in their preferred habitats, generally a certain depth of water or layer of water.

The fish food capsules are preferably spherical, oblong, oval, twist off or torpedo-shaped. However, any other form is possible. The fish food capsules have a size of 0.5 to 50 mm, preferably 2 to 40 mm, in particular 5 to 20 mm, wherein here, in the case of non-spherical formats, the greatest diameter in each case is stated.

The formation of a gas phase in the interior of the capsule is achieved as follows. First, the solid ingredients of the fish food product are mixed and ground. These are added to the lipophilic base mass. Further liquid components of the lipophilic base mass are then added. For avoiding premature gas escape during the production process, the liquid or suspension-like fish food product is thickened, i.e. its viscosity is increased. This can be achieved, for example, by incorporation into liquid beeswax. The viscosity can also be increased by adding thickeners such as alginic acid, agar, carrageenan, carob bean meal, guar flour, tragacanth, gum Arabic, xanthan, karaya, Tara flour, gellan, pectin, cellulose, cellulose ether, carboxymethyl cellulose, hydroxypropyl cellulose, hydroxypropylmethyl cellulose, methyl cellulose, methylethyl cellulose, modified starch, agar, gelatin, pectin, sago, PEG, polyacrylic acid or other cellulose derivatives.

Degassing of the fish food product then follows in order in particular to expel the reactive oxygen from the fish food product, which reactive oxygen would lead to oxidation and thereby to premature destruction of the food components.

In a further process step, a gas phase which does not react with the components of the food is introduced. In this case the thickened and degassed food is mixed under vigorous stirring with a gas or gas mixture. This process is carried out, for example, by means of an impeller having a gassing basket beneath which the gas outlet (fine bubbles) is mounted, with flow direction upwards. The amount of the added gas depends on the desired buoyancy which determines whether the food capsule floats, is suspended or sinks.

After the gas addition is terminated, the filling is encapsulated immediately under constant stirring and protective gassing in the form of a gas barrier, which preferably has the same composition as the gas phase introduced. The protective gassing not only protects the fish food product from oxygen contact and prevents introduction of oxygen into the fish food product, but by means of the stirring gas portions are again introduced into the fish food product, as a result of which the gas proportion in the fish food product can be kept virtually constant.

The gas used is preferably nitrogen, argon, carbon dioxide or another gas which does not react with the components of the fish food product. A nitrogen/argon mixture or another non-reactive gas mixture can also be used. Nitrogen or argon are non-hazardous to the fish and after digestion are excreted again, since during the eating process gases are regularly consumed which are then excreted with the feces.

The gas-containing fish food product is then enclosed by known methods in a capsule casing. Such methods are known from the encapsulation of drugs, food supplements or cosmetics. When soft gelatin is used, this is preferably an encapsulation process in which, on an encapsulation machine, two endless strips are formed from the gelatin solution with cooling, which strips are passed between two counterrotating shaping rollers. These rollers are provided with cup-shaped depressions, by means of which two mutually opposite pieces are stamped out in each case from the gelatin strips, which pieces in turn are welded to one another at the rim under pressure and a marked temperature. Immediately before the final closure of the encircling seam, synchronously with the rotation, by means of a pump and a connected radially tight fitting key, the flowable and pumpable capsule contents are injected.

A preferred production method comprises the process steps
1. Approximately ⅓ of the animal and/or vegetable oils required for the fish food product are charged into a separate container. The wax, preferably beeswax or another wax which is permitted to be used for producing food supplements is likewise charged into a separate container.
2. The wax is heated to 50-60° C.
3. The heated wax is mixed slowly with the oil under constant stirring. The mixture is cooled slowly below the melt temperature of the capsule casing material.
4. Addition of the other food components and also the remaining oil.
5. The fish food product is finely ground in a mill.
6. The fish food product is degassed.
7. Gassing the fish food product with a gas which does not react with the fish food product, preferably nitrogen or a nitrogen/argon mixture, with high dispersion. The amount of the added gas is determined by the desired sink or suspension behavior of the capsule.
8. Establishing a gas barrier.
9. Stirring the fish food product while retaining the gas barrier.
10. Encapsulating the fish food product.

In an alternative production method, the liquid wax phase and the fish food products are produced and degassed separately before being combined. The first third of the degassed fish food product is then added to the liquid wax phase and mixed therewith. In the remaining ⅔ of the fish food product, the non-reacted gas is dispersed. In a further process step, the fish food product which is admixed with non-reactive gas is stirred into the degassed wax/fish food product charge under a gas barrier. The completed fish food product is then encapsulated.

Furthermore, the fish food capsules can be generated by droplet formation. Using this technology, fish food capsules can be generated having a capsule size in the range from 0.5 to 5 mm, which are hollow spherical. In a preferred method, the hollow spheres are formed by coaxial droplet formation on which a gas stream, in particular a gas stream of a gas which does not react with the food components, or an oscillation, is superimposed. The capsule casing is formed by crosslinking in a crosslinking bath, precipitation, solidification or by other known chemical or physical processes employed in this sector of technology.

The fish food capsules can contain drugs for treating fish diseases for care of the fish in the event of disease. These can be combined alone or in combination with one or more other drugs and/or with a fish food product. The fish food capsules are preferably used for treating diseases or parasite infections such as “white spot disease both in fresh water and in sea water, Chilodonella cyprini, Costia, Trichodina, velvet disease, gill flukes, mycoses, lymphocystis, intestinal fladulates, Callamanus worm, and also bacterial or viral diseases or diseases due to spore forming creatures”. The drug-containing fish food capsules can be produced as edible food capsules or as slow-release capsules. A drug-containing fish food capsule is a capsule which has a size and flavor to be consumable by the fish. It serves for systemic treatment of the fish disease. Slow-release capsules are capsules which are sufficiently large, or have an adverse taste to the fish, and so are not consumed by the fish. They are placed in the surroundings of the fish. Slow-release capsules are configured, in particular, in such a manner that continuous release of the medicament proceeds over a long time period. This can be controlled via the dissolution behavior or the permeability of the capsule casing in the aqueous environment. By means of slow-release capsules, an external treatment, for example a treatment of parasites or fungi on the skin surface of the fish can be achieved by releasing the drug into the surroundings of the fish.

The invention also relates to a fish food kit consisting of various fish food capsules having buoyancy properties varying from one another and/or differing fish food products. Thereby, in one preparation, different fish types can be fed in their individual habitats, whereby here, the differing water layers (water surface, middle water layers, bottom) are meant. Each fish receives the food which is especially prepared and optimized for it, provided in its habitat. Targeted feeding of the fish in accordance with its requirements is possible thereby. Feeding competition and feeding envy due to food collection at the surface or at the bottom of the tank are avoided.

Hereinafter the invention will be described in more detail with reference to two exemplary embodiments.

In the figures

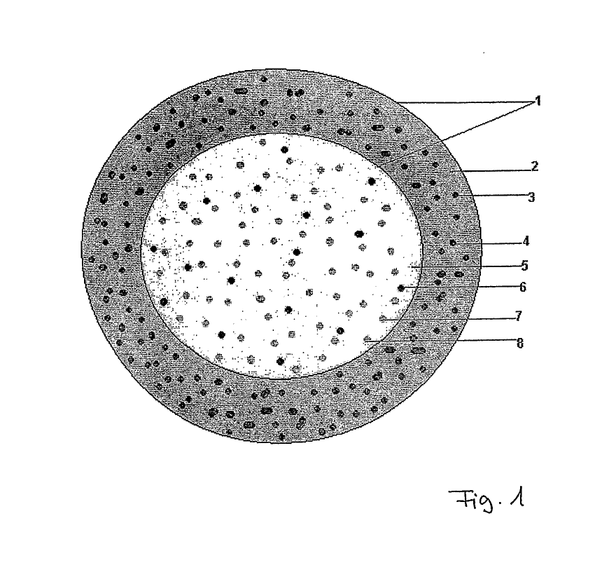

FIG. 1: shows a cross section or depiction of a fish food capsule,

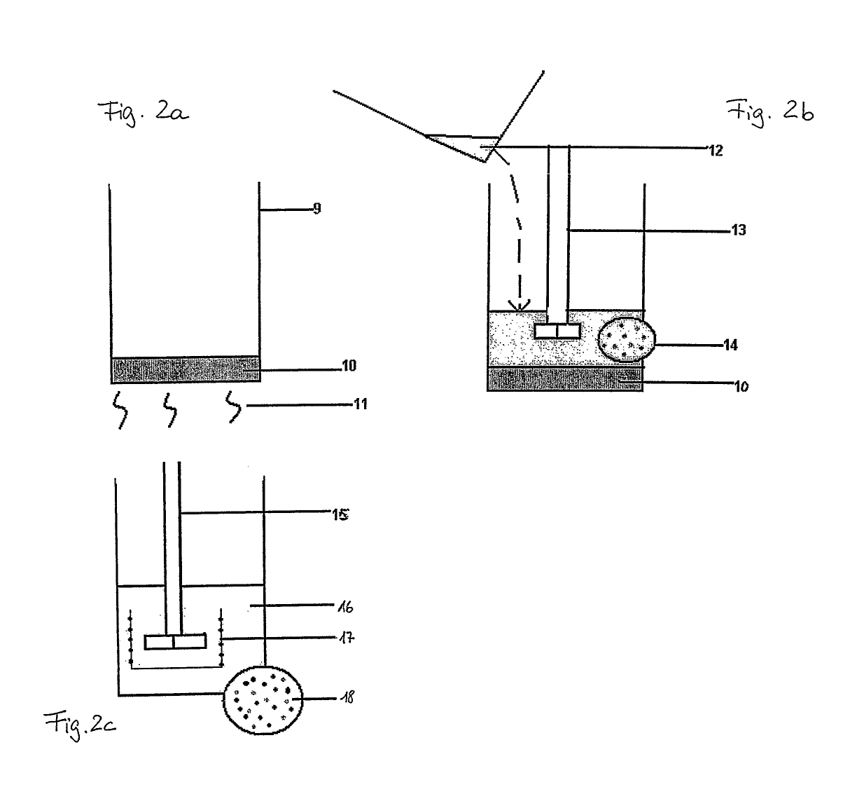

FIGS. 2a-c: show a schematic depiction of an alternative of the production method.

FIG. 1 shows a hollow spherical fish food capsule consisting of a capsule casing 1 and a fish food product 5 localized in the capsule interior. The capsule casing 1 consists of solid soft gelatin 2, in which dyes 3 and flavorings 4 are incorporated. The fish food product 5 consists of solid particles 7, in particular pulverized food creatures, and wax particles 8. In the fish food product 5, gas bubbles 6 are dispersed, the proportion of which in relation to the surface volume ratio and weight of the fish food capsule determines the buoyancy of the fish food capsule.

A schematic depiction of an alternative of the production method is shown in FIGS. 2a-c. The production unit comprises a tank 9 (FIG. 2a) in which a wax phase 10 is charged and heated to 50-60° C. by means of a heat source 11. FIG. 2b shows the process of mixing the wax phase 10 with food components 12 incorporated into a lipophilic base mass. For mixing the two phases, an agitator 13 is installed, by means of which a homogeneous mixture, the fish food product 14, is generated, with cooling the mixture of wax phase and oil. The degassing step is not shown. FIG. 2c shows the gassing of the degassed fish food product 16 using an agitator 15, below which a gassing basket 17 is mounted, by means of which the gas phase which does not react with the components of the fish food product is finely dispersed in the food 16. The dispersion 18 state is fine-bubbled and homogeneous.

### LIST OF REFERENCE NUMBERS

1 Capsule casing

2 Soft gelatin

3 Dye

4 Flavoring

5 Fish food product

6 Gas bubble

7 Solid particles, pulverized food animals

8 Wax particles

9 Tank

10 Wax phase

11 Heating means

12 Food components incorporated in a lipophilic base mass

13 Agitator

14 Fish food product, air-containing

15 Dispersing agitator

16 Degassed fish food product

17 Gassing basket

18 Dispersion

1. A fish food capsule comprising a capsule casing (1) and a liquid or suspension-like fish food product (5) enclosed in the capsule casing (1), characterized in that
a gas phase (6) determining the buoyancy of the fish food capsule is established in the capsule interior of the fish food capsule.

2. The fish food capsule as claimed in claim 1, characterized in that
the capsule casing (1) is formed from a compound selected from the group consisting of “gelatins (2) of animal origin, alginates, starch, polyvenyl alcohols, chitosans, carrageenan, cellulose derivatives, Eudragit®, immobilized materials which are metabolizable or excretable by water creatures”.

3. The fish food capsule as claimed in claim 1, characterized in that the capsule casing (1) is soluble in water.

4. The fish food capsule as claimed in claim 1, characterized in that
the capsule casing (1) contains colorants (3), flavor substances (4) and/or odor substances (4).

5. The fish food capsule as claimed in claim 1, characterized in that the liquid or suspension-like fish food product (5) comprises a liquid lipophilic base mass, in particular a vegetable or animal oil, liquid and/or solid food components (12) and a thickener (8), preferably a wax phase.

6. The fish food capsule as claimed in claim 5, characterized in that
the lipophilic base mass is a water-in-oil emulsion.

7. The fish food capsule as claimed in claim 5, characterized in that
the liquid and/or solid food components (12) are therapeutic agents or drugs, odor substances, flavor substances, lures, vitamins, carotinoids, dissolved minerals and trace elements, proteins, carbohydrates, milled and/or pulverized food animals (7) and/or fibers.

8. The fish food capsule as claimed in claim 1, characterized in that
the fish food capsule comprises two or more capsule parts which are different from one another, wherein the capsule parts contain different compositions of a fish food product, drug and/or a combination thereof.

9. The fish food capsule as claimed in claim 1, characterized in that
the gas phase (6) determining the buoyancy of the fish food capsule is a gas which does not react with the components of the fish food product.

10. The fish food capsule as claimed in claim 9, characterized in that the gas (6) which does not react with the components of the fish food product is selected from the group consisting of “nitrogen, argon, carbon dioxide or a mixture of two or more gases”.

11. A method for producing a fish food capsule as claimed in claim 1, characterized by the process steps:
1. charging a liquid wax phase (8) heated to 50-60° C.
2. adding ⅓ of the lipophilic base mass with stirring
3. cooling the wax/base mass mixture to a temperature below the melting point of the capsule casing material
4. while holding the temperature under point 3, adding further food components contained in the formula and also the remaining lipophilic base mass for completing the fish food product (14)
5. degassing the fish food product (14)
6. treating the fish food product (5) with a gas (6) which does not react with the components of the fish food product, to form a fine dispersion (18)
7. establishing a gas barrier, wherein, preferably, the gas barrier has the same gas composition as the introduced non-reactive gas (6), and constantly stirring the fish food product (5)
8. enclosing the fish food product (5) in the capsule casing (1).

12. A fish food kit consisting of various fish food capsules as claimed in claim 1 having buoyancy properties varying from one another and/or differing fish food products (5).

13. The use of a fish food capsule as claimed in claim 1 for water layer-orientated feeding of one or more selected fish types, in particular of ornamental or farmed fish types.

14. The use of a fish food capsule as claimed in claim 1 as lure and/or angling bait.

15. The fish food capsule as claimed in claim 2, characterized in that
the fish food capsule comprises two or more capsule parts which are different from one another, wherein the capsule parts contain different compositions of a fish food product, drug and/or a combination thereof.

16. The fish food capsule as claimed in claim 3, characterized in that
the fish food capsule comprises two or more capsule parts which are different from one another, wherein the capsule parts contain different compositions of a fish food product, drug and/or a combination thereof.
